(19) United States
(12) Patent Application Publication
(10) Pub. No.: US 2007/0271910 A1
(43) Pub. Date: Nov. 29, 2007

(54) Heat Exchange Tube Bundle for Regulating the Temperature of the Gases Entering an Internal Combustion Engine of a Motor Vehicle

(76) Inventor: Mathieu Chanfreau, Saulx Marchais (FR)

Correspondence Address: Valeo, Inc.;Intellectual Property Department, 4100 North Atlantic Boulevard, Auburn Hills, MI, 48326, US

(21) Appl. No.: 10/583,609

(22) PCT Filed: Dec. 15, 2004
(86) PCT No.: PCT/FR04/03223

§ 371 Date: May 3, 2007

(30) Foreign Application Priority Data
Dec. 24, 2003 (FR) 0315382

(51) Int. Cl. F02B 29/04

(52) U.S. Cl. 60/320

(57) ABSTRACT

The module comprises an intake air cooler (2) and a recirculated exhaust gas cooler (4). The intake air cooler (2) comprises an intake air inlet manifold (34) and an intake air outlet manifold (36). An inlet line (38) is connected to the inlet manifold (34) and an outlet line (40) is connected to the outlet manifold (36) of the feed air cooler (2). The recirculated exhaust gas cooler (4) comprises a recirculated exhaust gas inlet manifold (74) and a recirculated exhaust gas outlet manifold (76). A recirculated exhaust gas inlet line (42) is connected to the recirculated exhaust gas inlet manifold. A first bypass directly connects the inlet manifold to the outlet manifold of the recirculated exhaust gas cooler. Application to motor vehicles.

The invention relates to heat exchangers for cooling or heating the gases entering the combustion chambers of an internal combustion engine of a motor vehicle.

It relates more particularly to a heat exchange tube bundle comprising a feed air cooler and a recirculated exhaust gas cooler, the feed air cooler comprising a feed air inlet manifold and a feed air outlet manifold, a feed air inlet line being connected to the inlet manifold, and a feed air outlet line to the outlet manifold of the feed air cooler, the recirculated exhaust gas cooler comprising a recirculated exhaust gas inlet manifold and a recirculated exhaust gas outlet manifold, a recirculated exhaust gas inlet line being connected to the inlet manifold of the recirculated exhaust gas cooler.

Turbocharged internal combustion engines, particularly diesel or gasoline engines, are supplied with pressurized air called “supercharging air”, issuing from a turbocharger supplied with exhaust gases from the engine.

It is necessary to cool this air before it enters the engine. Conventionally, a cooler is used for this purpose, called a supercharging air cooler or more generally, a feed air cooler.

Moreover, it is known to recirculate part of the exhaust gases to the engine inlet for them to be more completely burnt. However, since these gases are at a very high maximum temperature (400° C. to 900° C.), it is known to cool them by circulating them in another heat exchanger supplied with a liquid coolant.

Architectures exist in which the supercharging air cooler is bypassed, either occasionally, or to improve the temperature rise of the engine in a cold starting phase. Architectures also exist in which the exhaust gas cooler is bypassed to reduce the pollution in a cold start phase.

However, these known architectures do not allow the regulation of the intake air temperature. The valves used to distribute the intake air between the supercharging air cooler and the bypass circumventing it, and to cool the recirculated exhaust gases between the recirculated exhaust gas cooler and the bypass which circumvents this cooler, serve to adjust respectively the feed air flow rate and the recirculated gas flow rate, not their temperature. The temperatures of the gaseous fluids leaving the coolers are accepted and not regulated.

A specific subject of the present invention is a heat exchange tube bundle which remedies these drawbacks. This object is achieved by the fact that the heat. exchange tube bundle of the invention comprises a first bypass directly connecting the inlet manifold to the outlet manifold of the recirculated exhaust gas cooler, and incorporated in the heat exchange tube bundle.

In a preferred embodiment of the invention, the heat exchange tube bundle comprises a second bypass directly connecting the inlet manifold to the outlet manifold of the feed air cooler and incorporated in the heat exchange tube bundle.

The incorporation of the bypass or bypasses in the heat exchange tube bundle serves to reduce its size and hence the volume occupied in the vehicle engine compartment. Furthermore, the connection of the module is simplified because it comprises a single feed air inlet and a single recirculated exhaust gas inlet.

In the above discussion, the expression “incorporated bypass” means that the bypass begins downstream of the feed air inlet or the recirculated exhaust gas inlet and terminates upstream of the outlet of the mixture of feed air and recirculated exhaust gases entering the chambers of the motor vehicle.

Advantageously, the heat exchange tube bundle comprises first distribution means for distributing the recirculated exhaust gases between the recirculated exhaust gas cooler and the first bypass.

It is further advantageous for the heat exchange module to comprise second distribution means for distributing the feed air between the feed air cooler and the second bypass.

In a preferred embodiment, the module of the invention comprises control means connected to the first and second distribution means for adjusting the proportion of cooled or heated inlet gases, inlet gases which have been neither cooled nor heated, cooled recirculated exhaust gases and recirculated exhaust gases which have been neither cooled nor heated, according to a predefined law.

In a particular embodiment, the first and second bypasses are different and separate from one another. In another particular embodiment, the first and second bypasses are merged in a single bypass.

Advantageously, the module comprises at least one proportional valve, for example a rotary valve, for managing both the intake air flow rate and the recirculated exhaust gas flow rate, and also the temperature of the intake mixture.

In a particular embodiment, the bypasses and intake air and recirculated exhaust gas distribution means constitute a submodule added on to the heat exchange tube bundle.

The inlet of the feed air in the inlet manifold of the feed air cooler and the outlet of this feed air, optionally mixed with the recirculated exhaust gases, from the outlet manifold of the feed air cooler, may be located on the same side of the heat exchange tube bundle. In another embodiment, the inlet of the feed air and the outlet of this feed air are located on different sides of the module.

The circulation of the recirculated exhaust gases in the recirculated exhaust gas radiator may take place in two passes along a U shaped route.

According to another feature of the invention, the heat exchange tube bundle comprises a recirculated exhaust gas inlet line which is connected to the outlet manifold of the recirculated exhaust gas cooler, the latter constituting the first bypass, the cooler comprising a transfer channel to convey the fraction of the recirculated exhaust gases to be cooled to the inlet manifold; a valve being arranged at the junction of the outlet manifold and the transfer channel to distribute the recirculated exhaust gases between the outlet manifold and the transfer channel.

According to an advantageous feature of the invention, the heat exchange tube bundle comprises a sensor of the feed air temperature located in a zone of the outlet manifold of the feed air cooler which is not traversed by the recirculated exhaust gases.

For this purpose, the recirculated exhaust gas cooler may have a length that is shorter than the length of the feed air cooler so as to arrange a zone of the outlet manifold of the feed air cooler which is not traversed y the recirculated exhaust gases.

According to another advantageous feature of the invention, the feed air cooler comprises a recirculated exhaust gas deflector, arranged facing the outlet of the recirculated exhaust gases in order to deviate these gases toward the outlet manifold of the feed air cooler to avoid the fouling of the tube bundle of the feed air cooler by the particulates from the recirculated exhaust gases and improve the feed air/recirculated exhaust gas mixture.

According to another feature of the invention, the recirculated exhaust gases pass from the outlet manifold of the recirculated exhaust gas cooler into the outlet manifold of the feed air cooler via an outlet orifice of which the cross section is smaller than or equal to the flow area for the gases in the recirculated exhaust gas cooler.

According to another feature of the invention, the recirculated exhaust gases pass from the outlet manifold of the recirculated exhaust gas cooler into the outlet manifold of the feed air cooler via an outlet orifice of which the cross section is longer than the flow area for the gases in the recirculated exhaust gas cooler the outlet manifold of the recirculated exhaust gas cooler and the outlet manifold of the feed air cooler being connected to each other by a divergent part.

According to a further feature of the invention, the recirculated exhaust gases flow directly into the outlet manifold of the feed air cooler, this manifold functionally playing the role of an outlet manifold for the recirculated exhaust gas cooler.

Other features and advantages of the invention will further appear from a reading of the description that follows for embodiments provided for illustration with reference to the figures appended hereto.

In these figures:

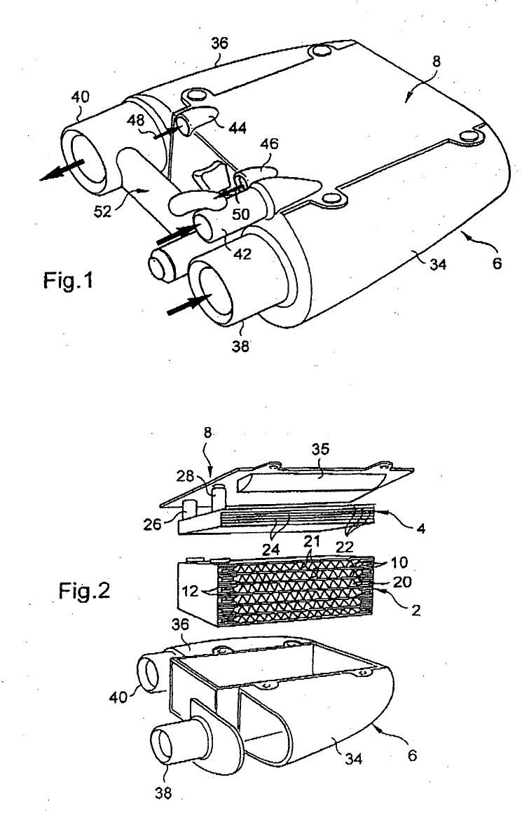

FIG. 1 is a perspective view of a heat exchange tube bundle according to a first embodiment of the invention, in the assembled state;

FIG. 2 is an exploded perspective view of the heat exchange tube bundle shown in FIG. 1;

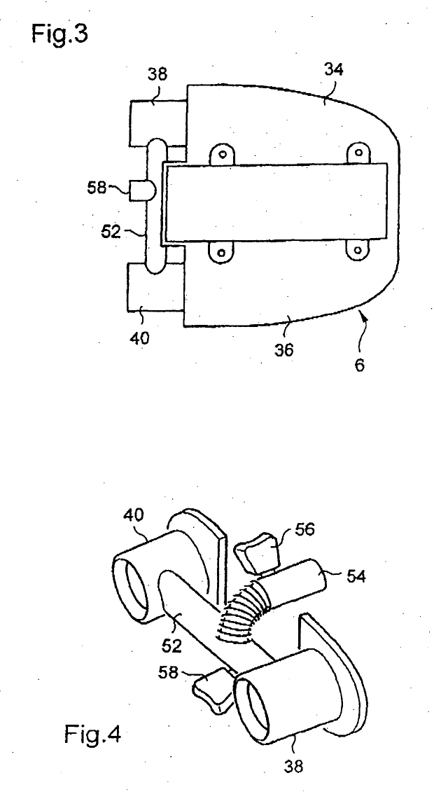

FIG. 3 is a bottom view of the heat exchange tube bundle shown in FIGS. 1 and 2;

FIG. 4 is a perspective detail view of a bypass of the heat exchange tube bundle in FIGS. 1 to 3;

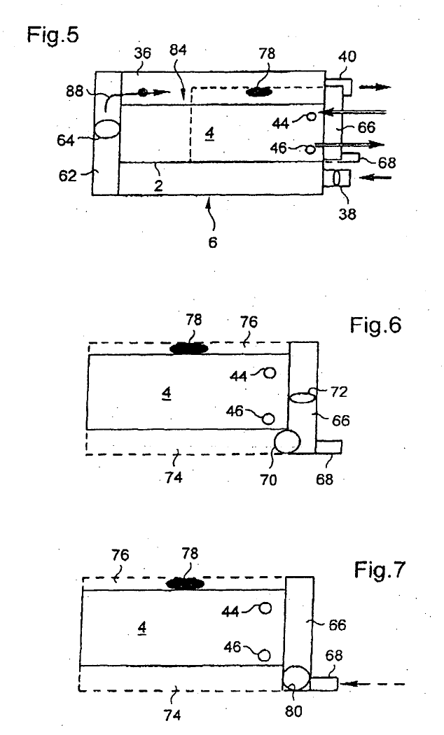

FIG. 5 is a schematic plan view of a heat 20 exchange tube bundle according to a second embodiment of the invention;

FIGS. 6 and 7 show variants of the embodiment of the heat exchange tube bundle in FIG. 5;

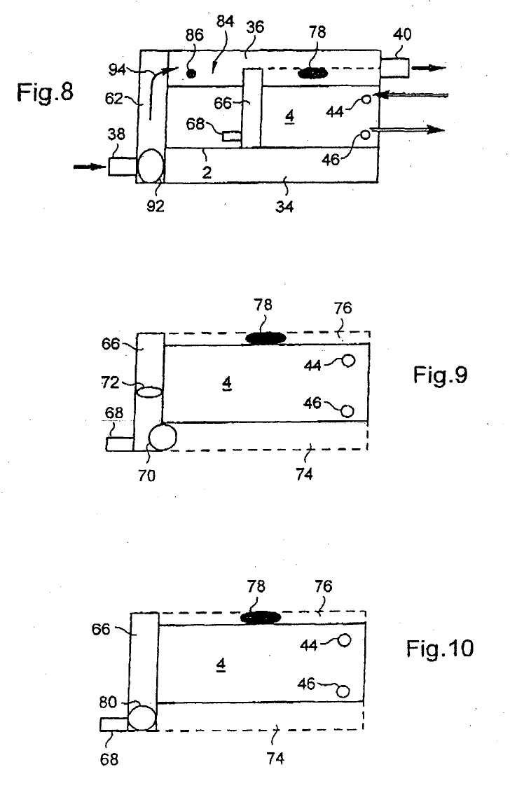

FIG. 8 is a schematic view of a heat exchange tube bundle according to a third embodiment of the invention;

FIGS. 9 to 11 show variants of the embodiment of the heat exchange tube bundle in FIG. 8;

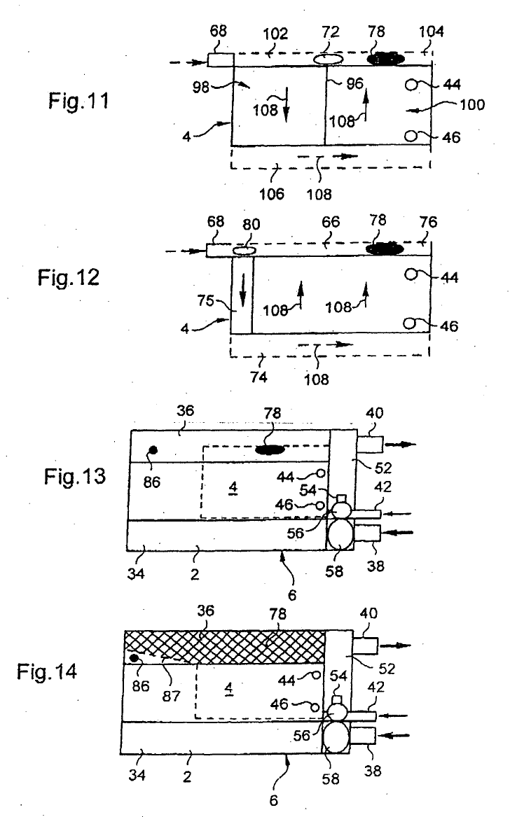

FIG. 12 is a variant of the embodiment in FIG. 11;

FIG. 13 is a schematic view of a heat exchange tube bundle according to a fourth embodiment of the invention;

FIG. 14 is a variant of the embodiment in FIG. 12; and

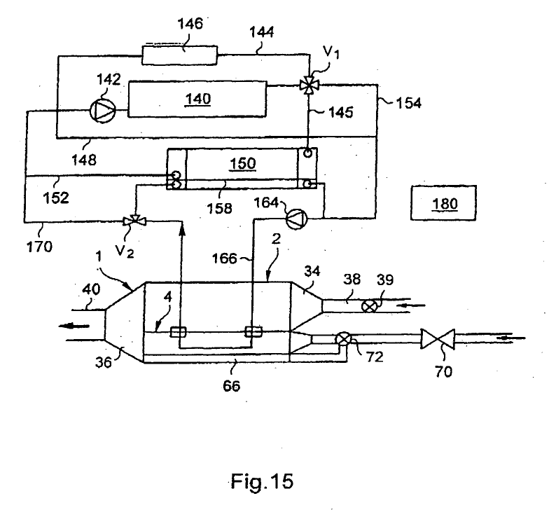

FIG. 15 is a schematic view of a heat exchange tube bundle comprising a single bypass.

FIG. 1 shows a perspective view and FIG. 2 an exploded perspective view of a heat exchange tube bundle according to the present invention for regulating the temperature of a mixture of intake air and recirculated exhaust gases. FIG. 3 is a bottom view of this module.

The module comprises a feed air cooler denoted by the general numeral 2 and a recirculated exhaust gas cooler denoted by the general numeral 4 (FIG. 2). The exhaust gas cooler 4 is arranged on the feed air radiator 2. In this embodiment, the two heat exchangers advantageously have the same depth and the same length to improve the feed air/recirculated exhaust gas mixture, but these lengths and depths could be different. The coolers 2 and 4 are mounted in a housing 6 closed by a lid 8.

In the example, the heat exchangers 2 and 4 are plate heat exchangers. The feed air cooler 2 consists of a superposition of stamped plates 10 of generally rectangular shape. Each plate comprises a substantially plane bottom wall surrounded by a peripheral ledge terminating in a flat. The bottom and ledge determine a shallow bowl shape designed for the flow of a coolant fluid. The plates are grouped in pairs assembled by their flats. Moreover, two bosses 12 are formed along a small side of the rectangle formed by each of the plates. The bottom of each boss 12 comprises a flow passage for the coolant fluid. The bosses of a pair of plates bear against the bosses of the pairs of adjacent plates. An inlet manifold and an outlet manifold are thereby produced for the coolant fluid.

The bosses of the pairs of plates mutually determine flow channels 20 for the feed air to be cooled. In general, corrugated inserts 21 are arranged in the flow channels 20.

Similarly, the exhaust gas cooler 4 consists of a superposition of plates 22 of generally rectangular shape, of which the configuration may be identical to or different from that of the plates of the feed air cooler. The plates 22 of the recirculated exhaust gas cooler 4 mutually determine passages 24 for the flow of the exhaust gases. The coolant fluid, generally water of the engine cooling circuit, flows in the bowls determined between the two plates of a given pair. Finally, the bosses of the plates determine an inlet manifold 26 and an outlet manifold 28 for the coolant fluid.

In the example, the cooling circuit of the feed air cooler 2 and the cooling circuit of the exhaust gas cooler 4 are mounted in parallel. In this way, the heat exchange tube bundle comprises a single inlet and a single outlet for the coolant fluid. The housing 6 is equipped with an inlet manifold 34 and an outlet manifold 36 for the feed air. The inlet manifold 34 comprises an air inlet line 38 and the outlet manifold 36 an air outlet line 40. The housing 6 further comprises a recirculated exhaust gas inlet line 42. On the other hand, there is no outlet of the recirculated exhaust gases, because these gases are mixed with the feed air and they consequently exit via the outlet line 40 of the heat exchange tube bundle.

The recirculated exhaust gas cooler 4 comprises an inlet manifold 35 arranged opposite the heat exchange tube bundle of the cooler and an outlet manifold (not shown) or no outlet manifold. In this case, the manifold 36 also serves as an outlet manifold for the recirculated exhaust gas cooler (FIG. 2). The inlet manifold 35 and the outlet manifold are fixed under the closure lid 8 of the housing 6 (FIG. 2).

As previously explained, the inlet and outlet of the coolant fluid, for example engine coolant, are common to the feed air cooler 2 and the recirculated exhaust gas cooler 4 (see FIG. 1). The cooling circuit water enters the heat exchange tube bundle via an inlet 44 as shown by the arrow 48 and is then distributed between the coolers 2 and 4. After flowing in the coolers, the cooling water leaves the heat exchange tube bundle via an outlet 46 as shown by the arrow 50.

According to a main feature of the invention, the heat exchange tube bundle shown in FIGS. 1 to 4 comprises a feed air bypass and a recirculated exhaust gas bypass, which are incorporated therein. More precisely, in this example, these two bypasses are merged in a single bypass denoted by the numeral 52 (see FIG. 1 and details in FIG. 4). The bypass line 52 is not necessarily located inside the housing 6 of the heat exchange tube bundle. On the contrary, as shown in FIGS. 1 to 4, it may be outside this housing. However, the bypass 52 is incorporated in the sense in which the inlet of this bypass is downstream of the feed air inlet 38 and of the recirculated exhaust gas inlet 42. Furthermore, the outlet of the common bypass of the feed air and recirculated exhaust gases is located upstream of the outlet line 40 common to these two gases.

As may be observed more particularly in FIG. 4, the heat exchange tube bundle comprises a line 54 through which the recirculated exhaust gases enter the bypass 52 in order to circumvent the heat exchange tube bundle of the cooler 4. A valve 56 is used to adjust the flow rate of these exhaust gases. Moreover, a valve 58 arranged on the bypass 52 is used to adjust the flow rate of feed air flowing through the bypass 52 and circumventing the heat exchange tube bundle of the radiator 2.

Advantageously, the valve 56 can singly and simultaneously manage the flow rate of recirculated exhaust gases passing into the bypass of the recirculated exhaust gas cooler and into the recirculated exhaust gas cooler. Similarly, the valve 58 can manage the flow rate of feed air which passes into the bypass of the feed air cooler and into the feed air cooler.

FIG. 5 shows a schematic view of an embodiment of a heat exchange tube bundle according to the invention. The heat exchange tube bundle has an elongated rectangular shape in a plan view. The inlet 38 of the feed air from the turbocharger of the engine and the outlet 40 of the mixture of feed air and cooled exhaust. gases are located along the same small side of the housing 6. A bypass 62 of the supercharging air cooler 2 is arranged along the opposite small side. A valve 64 is used to adjust the flow cross section of the bypass 62.

The recirculated exhaust gas cooler 4 is shown by a rectangle in dashed lines. It is located above the supercharging air cooler 2. In this example, its length is shorter than the length of the supercharging air cooler. A bypass 66 is used to circumvent the cooler 4. In the example, the bypass 66 is located along the same small side of the housing as the inlet 38 and the outlet 40. In other words, the bypass 62 and the bypass 66 are located along opposite sides of the heat exchange tube bundle. The recirculated exhaust gases enter via a line 68. This inlet is common to the cooler 4 and to the bypass line 66. The inlet 44 and the outlet 46 of the cooling water are common to the supercharging air radiator 2 and to the exhaust gas cooler 4.

FIGS. 6 and 7 show two variants of the embodiment of the cooler 4 which is part of the heat exchange tube bundle in FIG. 5.

In FIG. 6, the cooler 4 comprises two valves, that is, a flow valve 70 and a bypass valve 72. The valves 70 and 72 are used to adjust the flow rate of the recirculated exhaust gases, in other words, the fraction of exhaust gases leaving the engine and recirculated to be injected a second time into the combustion chambers of the engine. The unrecirculated fraction of the exhaust gases is discharged directly to the atmosphere. The bypass valve 72 is used to open or close the bypass. When the valve 72 is opened, the recirculated exhaust gases circumvent the cooler 4 and enter the outlet manifold 76 directly. On the contrary, when the valve 72 is closed, the exhaust gases pass through the heat exchange tube bundle of the cooler and are cooled before entering the outlet manifold 76. The exhaust gases, cooled or not, then leave the outlet manifold 76 via an outlet orifice 78 arranged therein and which communicates with the outlet manifold 36 of the supercharging air cooler 2. The orifice 78 has a cross section that is lower than or equal to the cross section of flow of the gases in the cooler 2. Advantageously, a deflector (not shown) may be provided in the outlet manifold 36 in order to deviate the exhaust gases. In FIGS. 6 and 7, the inlet manifold of the cooler 4 is denoted by the numeral 74.

The module according to the variant of embodiment shown in FIG. 7 comprises a single valve 80. This valve is used both to control the flow rate of the recirculated exhaust gases and for the opening and closing of the bypass line 66.

As explained above, the length of the exhaust gas cooler 4 is shorter than the length of the supercharging air cooler 2 so as to arrange a zone 84 of the outlet manifold 36 distant from the recirculated exhaust gas outlet 78 (FIG. 5). A temperature sensor 86 is arranged in the zone 84 in order to measure the intake air temperature.

Furthermore, as shown by the arrow 88, the flow direction of the intake air is defined so that this air encounters the temperature sensor 86 before reaching the exhaust gas cooler 4. Thanks to these arrangements, the temperature sensor 86 is not fouled by the soot contained in the recirculated exhaust gases.

FIG. 8 shows a schematic view of a third embodiment of a heat exchange tube bundle according to the invention. The supercharging air inlet at the turbocharger outlet 38 and the outlet of the gaseous mixture of air and cooled exhaust gases 40 are located along opposite small sides of the heat exchange tube bundle. A single valve 92 is used both to regulate the flow rate of the feed air and for the opening and closing of the bypass line 62 to bypass the supercharging air cooler 2. The exhaust gas cooler 4 comprises an inlet line 68 connected to the bypass line 66.

As in the previous embodiment (FIGS. 5 to 7), the length of the cooler 4 is shorter than the length of the supercharging air cooler 2 so as to arrange a zone 84 which is not polluted by the soot contained in the recirculated exhaust gases. The intake air temperature sensor 86 is located in this zone 84. As shown by the arrow 94, the feed air from the bypass line 62 flows in such a manner that the intake air passes over the temperature sensor 86 before being mixed with the recirculated exhaust gases, so that the sensor 86 is not fouled by the exhaust gases.

FIGS. 9 to 11 show three variants of embodiment of the recirculated exhaust gas cooler 4. In FIG. 9, this cooler comprises a valve 70 of the proportional type, for example a ball valve, which is used to adjust the flow rate of the recirculated exhaust gases and a valve 72, which operates in on/off mode, which is used to open or close the bypass line 66.

In FIG. 10, on the contrary, the recirculated exhaust gas radiator comprises a single valve simultaneously performing both functions of regulating the flow rate of the recirculated exhaust gases and opening and closing the bypass line 66.

Finally, in FIG. 11, the recirculated exhaust gas radiator comprises a partition 96 separating the heat exchange tube bundle into a zone 98 and a zone 100. The inlet manifold and the outlet manifold of the recirculated exhaust gases are not located on either side of the heat exchange tube bundle as in FIGS. 9 and 10, but along the same long side of the heat exchange tube bundle. The inlet manifold 102 and the outlet manifold 104 are separated from one another by a valve 72 located at the partition 96. On the other side of the heat exchange tube bundle is a compartment 106 for the passage of the exhaust gases from the heat exchange zone 98 to the zone 100. The recirculated exhaust gases thereby follow a U route as shown by the arrows 108.

FIG. 12 shows another variant of embodiment of the cooler 4 in which the recirculated exhaust gases flow in an “I” pattern. The recirculated exhaust gas inlet line 68 is connected to the outlet manifold 76 of the recirculated exhaust gas cooler 4. In this way, the recirculated exhaust gases directly enter the outlet manifold and exit via the orifice 78 without having to pass through a bypass line. The outlet manifold thus plays the role of a bypass. The fraction of gases to be cooled is conveyed upstream of the heat exchanger via a transfer channel 75 which terminates in the inlet manifold 74. A ball valve 80 is arranged at the junction of the outlet manifold 76 and the transfer channel 75. This valve regulates both the flow rate and distribution of the recirculated exhaust gases between the outlet manifold and the transfer channel. As a variant, two separate valves could be provided. The gases reaching the inlet manifold 74 pass through the heat exchanger tube bundle 4, as shown by the arrows 108 before leaving the heat exchanger via the orifice 78 and mixing with the uncooled fraction of the recirculated gases.

FIG. 13 shows yet another embodiment of a heat exchange tube bundle according to the invention. This embodiment corresponds to the perspective view which has been described with reference to FIGS. 1 to 4. The module comprises a single bypass line 52, common to the intake air and the recirculated exhaust gases. The inlet 38 of the intake air leaving the turbocharger and the outlet 40 of the mixture of intake air and cooled recirculated exhaust gases are located along the same small side of the housing 6 of the heat exchanger. The recirculated exhaust gases enter via an intake line 42. A line 54 is used to convey part of the recirculated exhaust gases to the bypass 52.

A valve 56, located at the connection of the lines 42 and 54, simultaneously regulates the flow rate of the recirculated exhaust gases and opens and closes the line 54, in other words, of the bypass of the recirculated exhaust gases. The single valve 58 simultaneously regulates the intake air flow rate at the outlet of the turbocharger and opens and closes the intake air bypass line 52.

In this embodiment, the length of the recirculated exhaust gas cooler is shorter than the length of the supercharging air cooler 2. However, in the operating mode with recirculated exhaust gases, in other words, when part of the exhaust gases is recirculated in the heat exchange tube bundle, the intake air temperature is not measured by the temperature sensor 86 located in the zone 84, but estimated by a predictive mathematical model, for example using a computer into which the values of the flow rates of air and exhaust gases, their temperature, etc., are introduced. The sensor thereby avoids the risk of fouling.

The assembly formed by the common bypass line 52, the inlet 38 and outlet 40 connected to this bypass line, the inlet 42 of the recirculated exhaust gases, the line 54 and the valve 56, and also the air flow control valve 58, can constitute a submodule added on to the main part of the heat exchange tube bundle of the invention.

FIG. 14 shows another variant of embodiment of the cooler 4 in FIG. 13. This embodiment is distinguished by the fact that the outlet orifice 78 extends along the whole length of the outlet manifold 76. Considering that, in this variant, the length of the cooler 4 is shorter than that of the feed air cooler 2, a wall constituting a divergent part 87 provides a transition between the two manifolds. The cross section of the outlet orifice 78 is higher than that of the recirculated exhaust gas cooler, thereby substantially reducing the pressure drops across the cooler 4 and improving the mixing of the feed air with the recirculated gases.

FIG. 15 shows a system for managing the heat energy of an engine 140 of a motor vehicle comprising a heat exchange tube bundle 1 according to the invention. It comprises a feed air cooler 2 and a recirculated exhaust gas cooler 4. The feed air enters the inlet manifold 34 via the line 38 on which a flow control valve 39 is mounted in order to adjust the negative pressure. This valve is optional. After cooling, the feed air passes into the outlet manifold 36 and leaves the cooler via the line 40. Contrary to the preceding embodiments, the feed air cooler does not comprise a bypass. All the feed air is cooled in the cooler 2. On the other hand, the recirculated exhaust gas cooler 4 comprises a bypass 66 as in the preceding embodiments. A flow valve 70 is mounted on the inlet line 68. A distribution valve 72 adjusts the distribution between the cooler and the bypass 66. The cooler 4 does not comprise an outlet manifold, because the outlet manifold 36 is common to the two coolers. The manifold 36 thus functionally plays the role of an outlet manifold for the recirculated exhaust gas cooler 4.

The module 1 is connected to the high and low temperature cooling circuits of the vehicle. The high temperature circuit comprises a main pump 142 which circulates a coolant liquid through the engine 140. After having traversed the engine, the liquid is distributed between various branches by a four-way valve V1. It may follow a bypass 144 on which a heating radiator 146 is mounted. The liquid may also follow a bypass line 148 which conveys it to the pump 142 without cooling. A third channel of the valve V1 is connected to a line 145 which conveys the coolant liquid to a high temperature radiator 150. At its exit, the liquid is returned to the pump by the line 152. Finally, a fourth channel of the valve V1 is connected to a line 154 which conveys the liquid to a low temperature radiator 158 in which it may be cooled to a lower temperature than in the high temperature radiator. A three-way valve V2 is arranged after the radiator. One channel V21 is connected to a line 166, comprising a circulating pump 164 and which traverses the coolers 2 and 4. One channel V22 is connected to the line leaving the low temperature radiator and a third channel to the line 170 which returns the liquid to the engine. According to the position of the valves V1 and V2, the module 1 is therefore supplied with liquid at high temperature (100° C.) or at low temperature (40° C. to 60° C.). The cooler 2 consequently operates in two modes. When it conveys liquid at low temperature, it serves as a feed air cooler. When it conveys liquid at high temperature, it serves as a feed air heater. On the other hand, the cooler 4 only operates as a recirculated exhaust gas cooler.

1. A heat exchange tube bundle for regulating the temperature of an intake air mixture and of recirculated exhaust gases entering an internal combustion engine of a motor vehicle, comprising a feed air cooler (2) and a recirculated exhaust gas cooler (4), the feed air cooler comprising a feed air inlet manifold (34) and a feed air outlet manifold (36), a feed air inlet line (38) being connected to the inlet manifold (34), and a feed air outlet line (40) to the outlet manifold (36) of the feed air cooler, the recirculated exhaust gas cooler (4) comprising a recirculated exhaust gas inlet manifold (74) and a recirculated exhaust gas outlet manifold (76), a recirculated exhaust gas inlet line (42, 68) being connected to the inlet manifold (74) of the recirculated exhaust gas cooler,
characterized in that it comprises a first bypass (52, 66) directly connecting the inlet manifold (74) to the outlet manifold (76) of the recirculated exhaust gas cooler (4), and incorporated in the heat exchange tube bundle.

2. The heat exchange tube bundle as claimed in claim 1, characterized in that it comprises a second bypass (52, 62) directly connecting the inlet manifold (34) to the outlet manifold (36) of the feed air cooler (2) and incorporated in the heat exchange tube bundle.

3. The heat exchange tube bundle as claimed in either of claims 1 and 2, characterized in that it comprises first distribution means (56, 70, 72, 80) for distributing the recirculated exhaust gases between the recirculated exhaust gas cooler (4) and the first bypass (52, 66).

4. The heat exchange tube bundle as claimed in either of claims 2 and 3, characterized in that it comprises second distribution means (58, 60, 92) for distributing the feed air between the feed air cooler (2) and the second bypass (52, 62).

5. The heat exchange tube bundle as claimed in claims 3 and 4, characterized in that it comprises control means (180) connected to the first and second distribution means for adjusting the proportion of cooled or heated inlet gases, inlet gases which have been neither cooled nor heated, cooled recirculated exhaust gases and recirculated exhaust gases which have been neither cooled nor heated, according to a predefined law.

6. The heat exchange tube bundle as claimed in one of claims 2 to 5, characterized in that the first and second bypasses are different and separate from one another.

7. The heat exchange tube bundle as claimed in one of claims 2 to 5, characterized in that the first and second bypasses are merged in a single bypass (52).

8. The heat exchange tube bundle as claimed in one of claims 1 to 7, characterized in that it comprises at least one proportional valve (80), for example a rotary valve, for managing both the intake air flow rate and the recirculated exhaust gas flow rate, and also the temperature of the intake mixture.

9. The heat exchange tube bundle as claimed in one of claims 4 to 8, characterized in that the bypasses and intake air and recirculated exhaust gas distribution means constitute a submodule added on to the heat exchange tube bundle.

10. The heat exchange tube bundle as claimed in one of claims 1 to 9, characterized in that the inlet (38) of the intake air in the inlet manifold (34) of the feed air cooler (2) and the outlet (40) of this feed air, optionally mixed with the recirculated exhaust gases, from the outlet manifold (36) of the feed air cooler, are located along the same side of the module.

11. The heat exchange tube bundle as claimed in one of claims 1 to 9, characterized in that the inlet (38) of the feed air in the inlet manifold (34) of the feed air cooler and the outlet (40) of this feed air, optionally mixed with the recirculated exhaust gases, from the outlet manifold (36.) of the feed air cooler (2), are located on different sides of the module.

12. The heat exchange tube bundle as claimed in one of claims 1 to 11, characterized in that the circulation of the recirculated exhaust gases in the recirculated exhaust gas cooler (4) takes place in two passes along a U route.

13. The heat exchange tube bundle as claimed in one of claims 1 to 12, characterized in that a recirculated exhaust gas inlet line (68) is connected to the outlet manifold (76) of the recirculated exhaust gas cooler (4), the latter constituting the first bypass (66), the cooler (4) comprising a transfer channel (75) to convey the fraction of the recirculated exhaust gases to be cooled to the inlet manifold (74) ; a valve (80) being arranged at the junction of the outlet manifold (76) and the transfer channel (75) to distribute the recirculated exhaust gases between the outlet manifold (76) and the transfer channel (75).

14. The heat exchange tube bundle as claimed in one of claims 1 to 13, characterized in that it comprises a sensor (86) of the intake air temperature located in a zone (84) of the outlet manifold (36) of the feed air cooler which is not traversed by the recirculated exhaust gases.

15. The heat exchange tube bundle as claimed in claim 14, characterized in that the recirculated exhaust gas cooler (4) has a length that is shorter than the length of the feed air cooler (2) so as to arrange a zone (84) of the outlet manifold of the feed air cooler which is .not traversed by the recirculated exhaust gases.

16. The heat exchange tube bundle as claimed in one of claims 1 to 15, characterized in that the feed air cooler (2) comprises a recirculated exhaust gas deflector (87) arranged facing the outlet (78) of the recirculated exhaust gases in order to deviate these gases toward the outlet manifold (36) of the feed air cooler (2).

17. The heat exchange tube bundle as claimed in one of claims 1 to 16, characterized in that the recirculated exhaust gases pass from the outlet manifold (76) of the recirculated exhaust gas cooler (4) into the outlet manifold (36) of the feed air cooler (2) via an outlet orifice (78) of which the cross section is smaller than or equal to the flow area for the gases in the recirculated exhaust gas cooler (4).

18. The heat exchange tube bundle as claimed in one of claims 1 to 16, characterized in that the recirculated exhaust gases pass from the outlet manifold (76) of the recirculated exhaust gas cooler (4) into the outlet manifold (36) of the feed air cooler (2) via an outlet orifice (78) of which the cross section is larger than the flow area for the gases in the recirculated exhaust gas cooler (4) and in that the outlet manifold (76) of the recirculated exhaust gas cooler (4) and the outlet manifold (36) of the feed air cooler (2) are connected to each other by a divergent part (87).

19. The heat exchange tube bundle as claimed in one of claims 1 to 18, characterized in that the recirculated exhaust gases flow directly into the outlet manifold (36) of the feed air cooler (2), this manifold functionally playing the role of an outlet manifold for the recirculated exhaust gas cooler (4).
